(19) United States
(12) Patent Application Publication
(10) Pub. No.: US 2013/0156090 A1
(43) Pub. Date: Jun. 20, 2013

(54) METHOD AND APPARATUS FOR ENABLING MULTIUSER USE

(71) Applicant: Adrian Rakar, Maple (CA)

(72) Inventor: Adrian Rakar, Maple (CA)

(73) Assignee: ATI TECHNOLOGIES ULC, Markham (CA)

(21) Appl. No.: 13/325,772

(22) Filed: Dec. 14, 2011

(51) Int. Cl. H04N 11/02; G06T 15/00

(52) U.S. Cl. 375/240.01; 345/419; 375/E07.026

(57) ABSTRACT

Methods and apparatus for enabling multiple user participation with a single multimedia computing platform and multiple displays. In particular, the methods enable multi-display rendering. For example, in a gaming environment, each user has the ability to select a particular view of the game that maybe different from other users and is private to that user. A system has a single multimedia computing platform with wired, wireless or combinations thereof. In a multiuser multiple display configuration, an application designates and renders particular or different frames to each of the users that may not be seen by the other users. Each frame is rendered from the perspective of the specific user or based on user selection. A display controller directs the frames to the appropriate displays. A video encoder engine encodes the frames and transmits the compressed frames to the appropriate wireless displays.

### FIELD OF INVENTION

The present invention is generally directed to processors.

### BACKGROUND

Multiple user participation in multiplayer games require the users to use a split screen, where the users share the same real estate on a single display, or connect up multiple computers or consoles via a network. This may be particularly evidenced in a home environment where most multimedia platforms are configured to operate with one display.

### SUMMARY OF EMBODIMENTS

Methods and apparatus enable multiple user participation with a single multimedia computing platform and multiple displays. In particular, multi-display rendering is enabled. For example, in a gaming environment, each user has the ability to select a particular view of the game that maybe different from other users and is private to that user. In an exemplary system there is provided a single multimedia computing platform, a wired display and multiple other displays (which may be wired or wirelessly connected to the multimedia computing platform). In a multiuser multiple display configuration, an application designates and renders particular frames to each of the users that may not be seen by the other users. Each frame is rendered from the perspective of the specific user or based on user selection. A display controller directs the frames to the appropriate displays. A video encoder engine encodes the frames and transmits the compressed frames to the appropriate displays.

In an exemplary multimedia platform, multiple buffers receive frames from a three dimensional (3D) application. Each frame represents a different view of a scene. A display controller reads each frame from the multiple buffers and redirects each frame to a corresponding display in response to a display select from a driver. The display controller renders each frame at the corresponding display.

Another exemplary multimedia platform includes a memory that receives a left eye frame and a right eye frame from a three dimensional (3D) application, where the left eye frame and the right eye frame each represents a different view of a scene. A display controller reads one frame of the left eye frame and the right eye frame from the memory and redirects the one frame to a corresponding display upon direction of a driver. The display controller renders the frame at the corresponding display. The display controller reads a remaining frame from the memory and redirects the remaining frame to another corresponding display when an active space region between the left eye frame and the right eye frame is reached and upon direction from the driver. The display controller renders the remaining frame at the another corresponding display.

### BRIEF DESCRIPTION OF THE DRAWINGS

A more detailed understanding may be had from the following description, given by way of example in conjunction with the accompanying drawings, wherein:

FIG. 1 is a block diagram of a system using a shared display;

FIG. 2 is an example block diagram of a system using frame sequential processing with a single multimedia platform and multiple displays;

FIG. 3 is an example block diagram of a system using stereoscopic 3D processing with a single multimedia platform and multiple displays; and

FIG. 4 is an example stereographic 3D frame.

### DETAILED DESCRIPTION

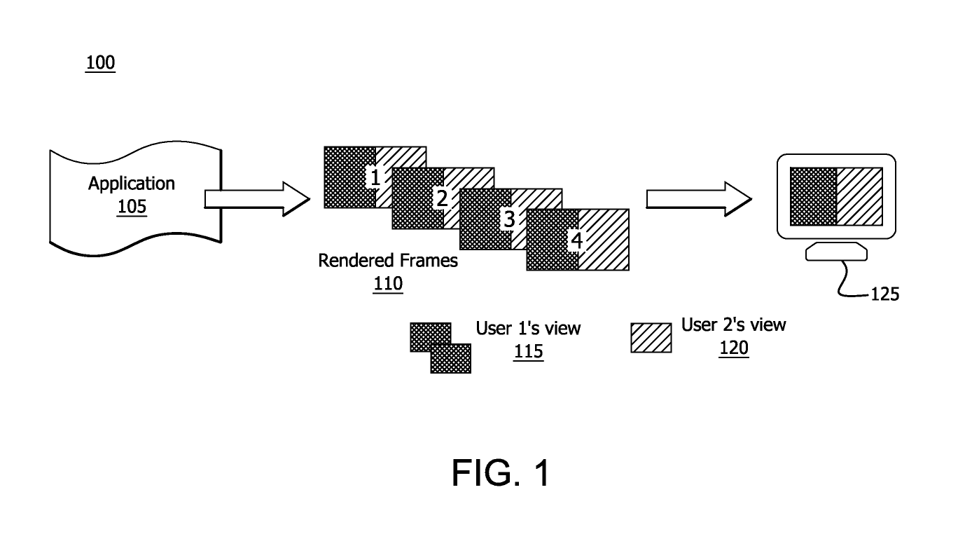

FIG. 1 is a block diagram of a multimedia platform 100 where a multiplayer game application 105 renders surfaces or frames 110 on a single display 125. As a result of having the single display 125 and the need for each user to see their specific view, the surfaces or frames 110 are each subdivided to show all users views simultaneously on the single display 125. For example, surfaces or frames 110 depict a user 1's view 115 on the left side and a user 2's view 120 on the right side. Disadvantageously, the useable screen space is reduced for each user, therefore there is a practical limitation to how many users can share the same display and each user's view is not private and can be seen by all of the other users. In another scenario, each user may have their own computer/console and display but these are typically connected via a network, (local or internet). Disadvantageously, each user is required to have a computer/console.

Described herein are methods and apparatus for multiple users to participate in a game using a single multimedia platform connected to multiple displays. For example, a residence may only have a single videogame console but multiple televisions. In particular, N users may participate simultaneously in a game, where each user has a dedicated display and view. Although the description is presented in terms of multiplayer gaming, the methods and apparatus may be applied to a variety of applications.

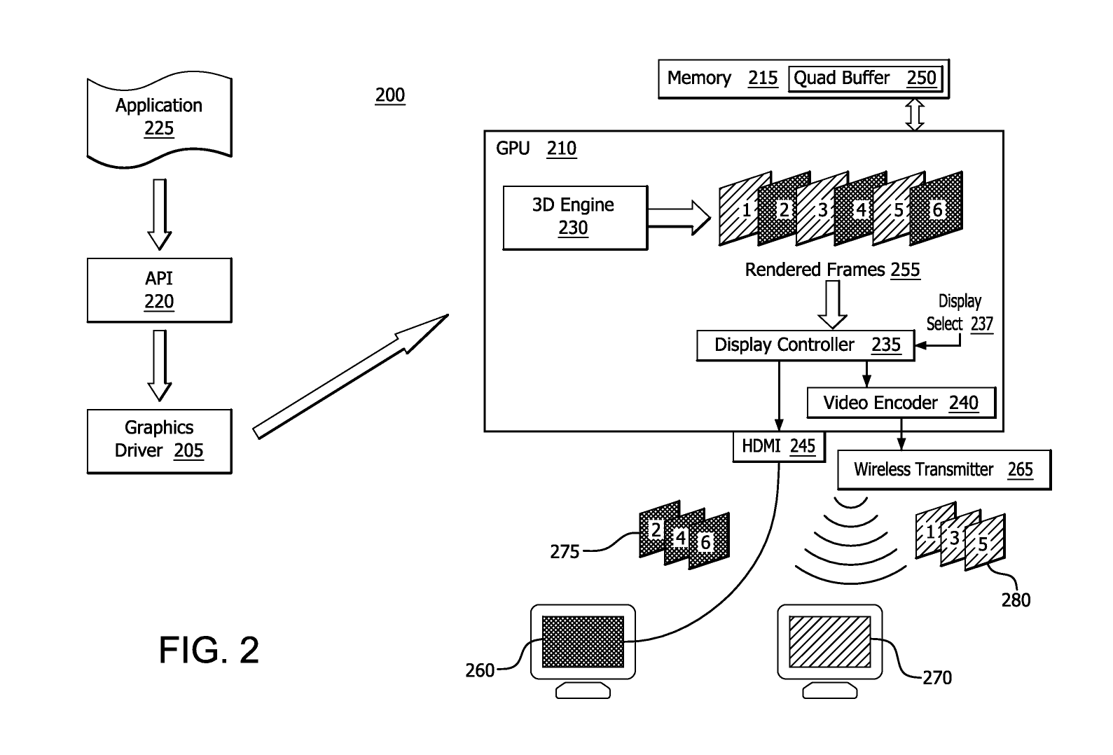

FIG. 2 is a block diagram of a multimedia platform 200 that may be, for example, a computer, a gaming device, a handheld device, a set-top box, a television, or a tablet computer. The multimedia platform 200 includes a graphics driver 205, a graphics processing unit (GPU) 210, and a memory 215. A person of skill in the art will appreciate that multimedia platform 200 may include software, hardware, and firmware components in addition to, or different from, that shown in FIG. 2. It is understood that the multimedia platform 200 may include additional components not shown in FIG. 2.

The memory 215 may be located on the same die as the GPU 210, or may be located separately from GPU 210. The memory 215 may include a volatile or non-volatile memory, for example, random access memory (RAM), dynamic RAM, or a cache. The graphics driver 210 may comprise software, firmware, hardware, or any combination thereof. In an embodiment, the graphics driver 210 may be implemented entirely in software. The graphics driver 210 may provide an interface and/or application programming interface (API) 220 for applications 225 executing on a central processing unit (CPU) to access the GPU 210.

The GPU 210 provides graphics acceleration functionality and other compute functionality to multimedia platform 200. The GPU 210 may include a 3D engine 230, a display controller 235, a video encoder 240 and a port 245. The port 245 may be a High-Definition Multimedia Interface (HDMI) port or other like wired connector. GPU 210 may include a plurality of processors including processing elements such as arithmetic and logic units (ALU). It is understood that the GPU 210 may include additional components not shown in FIG. 2.

Application 225, such as a 3D application, nominally renders frames/surfaces for a single user using a multi-buffer or a quad buffer 250 implemented in memory 215. In this example, a surface may refer to a memory location allocated for a specific purpose, for example, to hold the image of a visible frame. The terms surface and frame may be used interchangeably in this description. Each one of these frames/surfaces is typically rendered with the view of the single user. In a multiuser configuration, (as may be selected by the users), the application 225 may dedicate each of the rendered frames/surfaces 255 to a different user. Each rendered frame/surface 255 being rendered with the view of a different user. The multimedia platform 200 makes use of existing video encoder blocks and wireless display features to simultaneously enable a single wired display and N wireless displays. In another example, there may multiple wired and/or wireless displays.

Application 225 ensures that the frames/surface 255 of a user are rendered correctly at the user's display. For example, application 225 would ensure that frames 1, 3 and 5 contain the view for user A. The driver 205 and display controller 235 are responsible for knowing that a frame is intended for a particular user and redirecting the frame accordingly. For example, within the display controller 235, the display pipe, which may be a single pipe or multiple pipes, reads the frame/surface contents 255 and redirects the frame/surface 255 to either a wired display 260 via a port 245, (where port 245 may be a High-Definition Multimedia Interface (HDMI) port or any other form of wired connector), or to the video encoder 240 for wireless transmission. The display controller 235 reads the frames/surfaces from quad memory 250 when the surfaces are completed. The display controller 235 is driven or directed by the graphics driver 205 via a display select 237 to redirect selected frames/surfaces to the correct display.

The video encoder 240 encodes the frames/surfaces and forwards the compressed frames to a wireless transmitter 265, which in turn transmits the compressed frames to the appropriate wireless display 270, (each wireless display 270 having a wireless receiver). As a result, frames/surfaces 275 are displayed at wired display 260 and frames/surfaces 280 are displayed at wireless display 270. As will be appreciated various combinations of wired and wireless displays are possible. For example, all displays may be wired, wireless or a combination thereof.

In this example, the display controller 235 may run at N times the normal frequency so that it may provide sufficient bandwidth to drive all the displays.

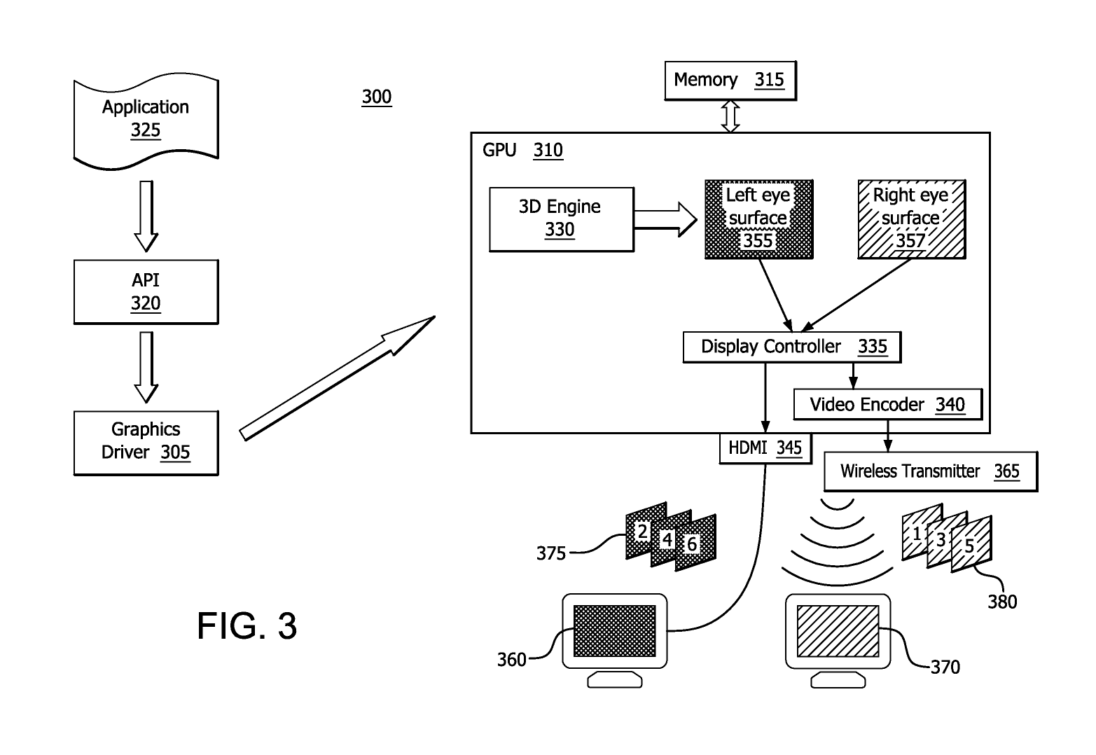

FIG. 3 is a block diagram of a multimedia platform 300 that may be, for example, a computer, a gaming device, a handheld device, a set-top box, a television, or a tablet computer. The multimedia platform 300 includes a graphics driver 305, a graphics processing unit (GPU) 310, and a memory 315. A person of skill in the art will appreciate that multimedia platform 300 may include software, hardware, and firmware components in addition to, or different from, that shown in FIG. 3. It is understood that the multimedia platform 300 may include additional components not shown in FIG. 3.

The memory 315 may be located on the same die as the GPU 310, or may be located separately from GPU 310. The memory 315 may include a volatile or non-volatile memory, for example, random access memory (RAM), dynamic RAM, or a cache. The graphics driver 310 may comprise software, firmware, hardware, or any combination thereof. In an embodiment, the graphics driver 310 may be implemented entirely in software. The graphics driver 310 may provide an interface and/or application programming interface (API) 320 for applications 325 executing on a central processing unit to access the GPU 310.

The GPU 310 provides graphics acceleration functionality and other compute functionality to multimedia platform 300. The GPU 310 may include a 3D engine 330, a display controller 335, a video encoder 340 and a port 345. GPU 310 may include a plurality of processors including processing elements such as arithmetic and logic units (ALU). It is understood that the GPU 310 may include additional components not shown in FIG. 2.

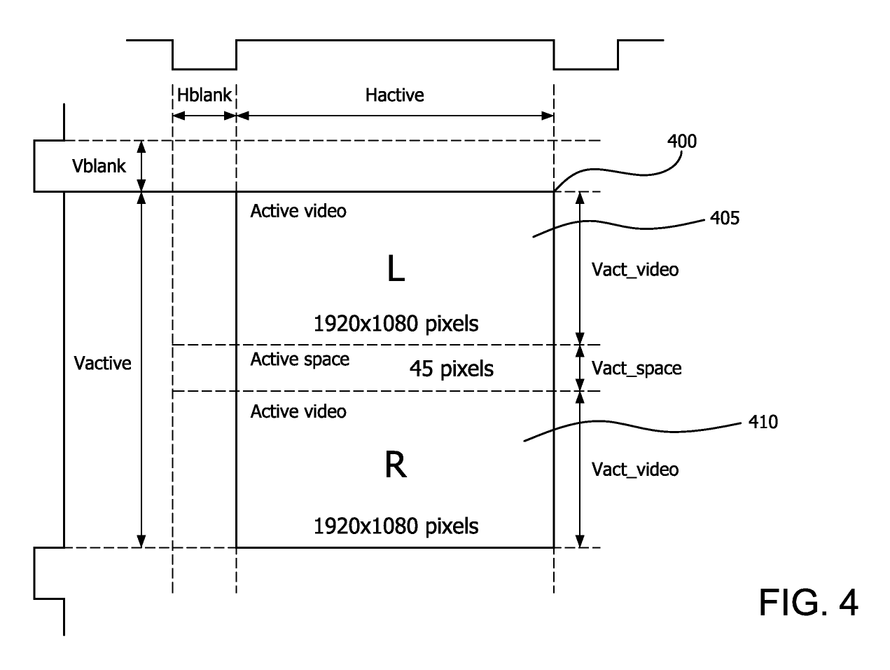

Application 325, such as a 3D application, nominally uses a stereographic 3D process in which a left eye surface/frame and a right eye surface/frame are rendered. As shown in FIG. 4, a left eye surface 405 and a right eye surface 410 are then combined in a top/bottom dual frame structure 400 before being transmitted to the single display.

In a multiuser configuration, the 3D application 325 may instead render a user 1 surface 375 and user 2 surface 380. The display controller 335, at the direction of the driver 305, would then redirect each of the surfaces, i.e., the user 1 surface 375 and user 2 surface 380, to the appropriate display. The switch would occur in the “active space” region between the two frames. For example, during the active space region or period, the display controller 335 would be directed by the driver 305 to switch the display controller's output to the appropriate display.

In particular, the display controller 335 may read the user 1 surface 355 and user 2 surface 357 and redirect to either a wired display 360 via a port 345 or to the video encoder 340 for wireless transmission. In another example, there may multiple wired and/or wireless displays. The video encoder 340 encodes the frames/surfaces and forwards the compressed frames to a wireless transmitter 365, which in turn transmits the compressed frames to the appropriate wireless display 370, (each having a wireless receiver). As a result, frames/surfaces 375 are displayed at wired display 360 and frames/surfaces 380 are displayed at wireless display 370.

In general, an exemplary multimedia platform includes multiple buffers that receive sequential frames from a three dimensional (3D) application. Each frame representing a different view of a scene that may be selectable by a user. A display controller reads each frame from the multiple buffers and redirects each frame to a corresponding display in response to a display select from a driver. The display controller renders each frame at the corresponding display. A video encoder encodes the frame for wireless transmission on a condition that the corresponding display is a wireless display. A transmitter transmits an encoded frame to the wireless display. There may be N frames that correspond to N displays, where each frame is private to each display. The displays may be wired or wireless displays.

Another exemplary multimedia platform includes a memory that receives a left eye frame and a right eye frame from a three dimensional (3D) application, where the left eye frame and the right eye frame each represents a different view of a scene. A display controller reads one frame of the left eye frame and the right eye frame from the memory and redirects the one frame to a corresponding display upon direction of a driver. The display controller renders the frame at the corresponding display. The display controller reads a remaining frame from the memory and redirects the remaining frame to another corresponding display when an active space region between the left eye frame and the right eye frame is reached and upon direction from the driver. The display controller renders the remaining frame at the another corresponding display. As described herein, a video encoder encodes frames and a transmitter transmits encoded frames that are directed to wireless displays.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Although features and elements are described above in particular combinations, each feature or element may be used alone without the other features and elements or in various combinations with or without other features and elements. The methods provided may be implemented in a general purpose computer, a processor or any IC that utilizes timestamps. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions (such instructions capable of being stored on a computer readable media). The results of such processing may be maskworks that are then used in a semiconductor manufacturing process to manufacture a processor which implements aspects of the present invention.

What is claimed is:

1. A multimedia platform, comprising:
multiple buffers configured to receive multiple frames from a three dimensional (3D) application, wherein each frame represents a different view of a scene;
a display controller configured to read each frame from the multiple buffers;
the display controller configured to redirect each frame to a corresponding display in response to a display select from a driver; and
the display controller configured to render each frame at the corresponding display.

2. The multimedia platform of claim 1, further comprising:
a video encoder configured to encode the frame for wireless transmission on a condition that the corresponding display is a wireless display.

3. The multimedia platform of claim 2, further comprising:
a transmitter configured to transmit an encoded frame to the wireless display.

4. The multimedia platform of claim 1, wherein N frames correspond to N displays.

5. The multimedia platform of claim 1, wherein each frame is private to each corresponding display.

6. The multimedia platform of claim 1, wherein the corresponding display is one of a wired display or a wireless display.

7. The multimedia platform of claim 6, wherein the different view is selectable.

8. A multimedia platform, comprising:
a memory configured to receive a left eye frame and a right eye frame from a three dimensional (3D) application, wherein the left eye frame and the right eye frame each represents a different view of a scene;
a display controller configured to read one frame of the left eye frame and the right eye frame from the memory;
the display controller configured to redirect the one frame to a corresponding display upon direction of a driver;
the display controller configured to render the frame at the corresponding display;
the display controller configured to read a remaining frame from the memory;
the display controller configured to redirect the remaining frame to another corresponding display when an active space region between the left eye frame and the right eye frame is reached and upon direction from the driver; and
the display controller configured to render the remaining frame at the another corresponding display.

9. The multimedia platform of claim 8, further comprising:
a video encoder configured to encode the one frame or remaining frame for wireless transmission on a condition that the one frame or remaining frame is directed to a wireless display.

10. The multimedia platform of claim 9, further comprising:
a transmitter configured to transmit an encoded frame to the wireless display.

11. The multimedia platform of claim 8, wherein N frames correspond to N displays.

12. The multimedia platform of claim 8, wherein the one frame is private to the corresponding display and the remaining frame is private to the another corresponding display.

13. The multimedia platform of claim 8, wherein the different view is selectable.

14. A method for enabling multiple display rendering, comprising:
storing multiple frames from a three dimensional (3D) application, wherein each frame represents a different view of a scene;
reading each frame from the multiple buffers;
redirecting each frame to a corresponding display in response to a display select from a driver; and
rendering each frame at the correspondng display.

15. The method of claim 14, wherein each frame is private to each corresponding display.

16. The method of claim 14, wherein the different view is selectable.

17. The method of claim 14, further comprising:
encoding each frame for wireless transmission on a condition that the corresponding display is a wireless display.

18. A computer-readable storage medium configured to store a set of instructions used for manufacturing an electronic device, wherein the electronic device comprises:
multiple buffers configured to receive multiple frames from a three dimensional (3D) application, wherein each frame represents a different view of a scene;
a display controller configured to read each frame from the multiple buffers;
the display controller configured to redirect each frame to a corresponding display in response to a display select from a driver; and
the display controller configured to render each frame at the corresponding display.

19. The computer-readable storage medium of claim 18, wherein the instructions are Verilog data instructions.

20. The computer-readable storage medium of claim 18, wherein the instructions are hardware description language (HDL) instructions.
